(19) United States
(12) Patent Application Publication
(10) Pub. No.: US 2017/0010086 A1
(43) Pub. Date: Jan. 12, 2017

(54) Grating Light Valve Based Optical Coherence Tomography

(71) Applicant: Balasigamani Devaraj, Noida (IN)

(72) Inventor: Balasigamani Devaraj, Noida (IN)

(21) Appl. No.: 14/792,584

(22) Filed: Jul. 6, 2015

(51) Int. Cl. G01B 9/02

(52) U.S. Cl. CPC G01B 9/02001; G01B 9/02091; G01B 9/02049

(57) ABSTRACT

We propose an Optical Coherence Tomography (OCT) system where a grating light valve is placed in front of the detector to make the interferometer more sensitive and accurate for reading various samples for diagnosis.

### FIELD OF THE INVENTION

The present invention relates to the field of optical measurement devices. More particularly, the present invention relates to the field of optical test and measurement, interferometry, optical ranging and imaging, of a specimen using optical coherence tomography.

### BACKGROUND OF THE INVENTION

Optical coherence tomography (“OCT”) is a technology that allows for noninvasive, cross-sectional optical imaging in biological as well as non-biological media with high spatial resolution and high sensitivity. OCT is an extension of low coherence or white-light interferometry, in which a low temporal coherence light source is utilized to obtain precise localization of reflections internal to a probed structure along an optic axis (i.e., as a function of depth into the sample). An optical beam is directed at the tissue, and a small portion of this light that reflects from sub-surface features is collected. In the OCT instrument, an optical interferometer is used in such a manner as to detect only coherent light. In the process the depth and the intensity of the light reflected from a sub-surface feature is obtained. The most commonly used interferometers in these devices are Michelson interferometer and Mach-Zehnder interferometer (MZI).

In typical OCT interferometric systems are based on a Michelson Interferometer. The signal is detected by a grating based spectrometer equipped with a linear detector array (or a line-scan camera). Further, OCT interferometric system known in the art are complex in arranging optical devices, expensive and are not portable.

### SUMMARY

In view of the foregoing disadvantages inherent in the prior art, the general purpose of the present invention is to provide a novel compact, affordable optical test, measurement or imaging device that is configured to include all advantages of the prior art, and to overcome the drawbacks inherent therein.

In a preferred embodiment, an interferometric system that comprises a Mach-Zehnder interferometer, and a grating-light-valve (GLV) which is also a frequency (i.e., wavelength)-tunable filter. The GLV separates the input broad-band light into light with narrow-band-wavelengths and outputs them sequentially at different time intervals in a single output fiber.

In an aspect of the present invention, an interferometric system for imaging a biological sample is provided. The interferometric system comprises a broadband light source, a plurality of beam splitters, a plurality of mirrors, a sample, a GLV, and a detector.

In another aspect of the present invention, a method for ranging reflectors within a sample is provided. The method includes light from the broadband light source which is operating at a suitable center wavelength enters into a Mach-Zehnder interferometer where it gets separated into a sample arm and a reference arm using a first optic beam splitter. A light from the reference arm gets reflected by mirror and reaches a second beam splitter. A light from the sample arm enters into the sample through a third beam splitter, and the back scattered light from the sample gets reflected at the third beam splitter, and enters into a second beam splitter (typically, but not limited to, 99% transmittance, 1% reflectance). The light from the sample and reference arms, interfere with each other at the second beam splitter before entering a GLV which wavelength-division-multiplexes the interfered light, and then finally enters into a detector for analysis.

These together with the other aspects of the present invention, along with the various features of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and in which:

FIG. 1 illustrates an optical diagram of a prior-art Mach-Zehnder Interferometric apparatus and system.

FIG. 2 illustrates an optical diagram of the Mach-Zehnder Interferometric apparatus and system configured with a GLV in accordance with an embodiment as disclosed.

Other features of the present embodiments will be apparent from the accompanying figures and from the detailed description that follows.

### DETAILED DESCRIPTION OF THE INVENTION

The present invention proposes an interferometric system for optical imaging. In particular, the invention is an integrated system for detection, ranging, metrology and multi-dimensional imaging.

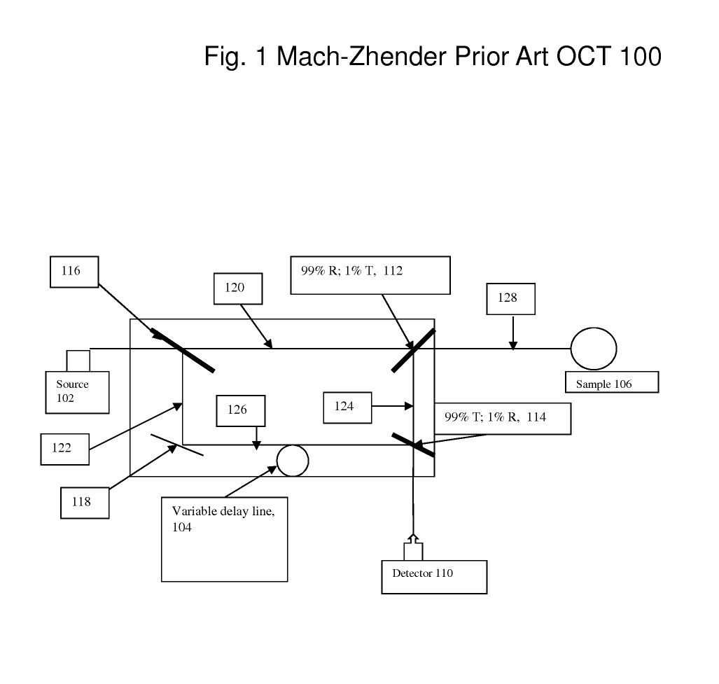

In U.S. Pat. No. 7,079,256 B2, the Mach-Zehnder interferometer (MZI) is built using bulk optical elements and uses time-domain form of optical coherence-tomography. FIG. 1 illustrates an optical diagram of a Mach-Zehnder Interferometric optical coherence tomography system (100) as described in the prior art. In the system source 102 emits a beam of light. The light can optionally be broadband light. The beam splits at the first beam splitter (116) (typically 99% Transmittance and 1% Reflectance) getting divided into two separate light beams known as reference arm or reference path (122) and sample arm or sample path (120). The reference arm beam (122) is reflected by a scanning minor 118 towards a second beam splitter (114) (typically 99% Transmittance and 1% Reflectance). The beam reflected from the mirror 118 is labeled (126). The sample arm beam (120) is passed through a third beam splitter (112) (typically 99% Reflectance and 1% Transmittance) to provide beam 128 which reflects the light to the sample (106). The sample beam is scattered and/or reflected back after it strikes the sample and is known as the backscattered sample beam. The backscattered sample beam strikes the third beam splitter (112). The third beam splitter (112) reflects the backscattered sample beam to the second beam splitter (114) (typically, but not limited to, 1% Reflectance and 99% Transmittance).

The reference arm beam (126) reflected from minor 118 gets reflected at the beam-splitter 114 towards the detection optics and electronics. The backscattered sample arm beam (124) reflected from third beam splitter (112) gets transmitted through the beam-splitter 114. Both the beams 124 and 126 interfere with each other at the beam-splitter 114. The interference light beam enters a detector 110.

All the major components of the Mach-Zehnder interferometer including 102, 116, 120, 112, 124, 114, 126, 118, 122 form an interferometer sub-assembly 100.

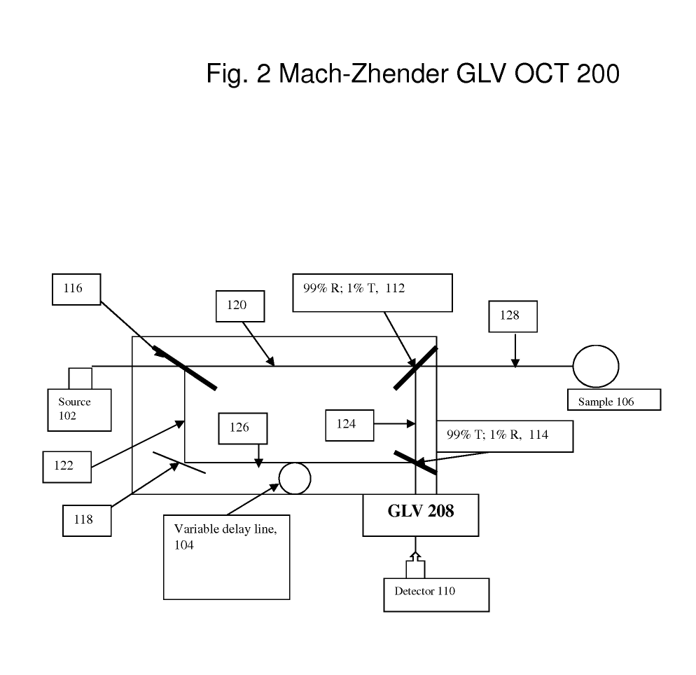

FIG. 2 illustrates an optical diagram of a Mach-Zehnder Interferometric optical coherence tomography system (200) configured with a GLV 208, in accordance with an embodiment of the present invention. Using the GLV 208, wavelength division multiplexing of interfered light beam (124) takes place. The multiplexed data enters a detector 110 which converts light into an electronic signal.

The traditional spectral domain OCT systems use a broad-band source and a spectrometer. However, replacing the spectroscopic detection using the GLV and a single detector reduces the cost as we do not need to use a full line-scan camera. Since there is only 1 detector, our invention provides the following advantages: smaller form factor, lower cost, and higher efficiency. There are inherent losses in a grating based spectrometer (sometimes as high as 70-90%). Those losses are minimized in the proposed invention.

It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A Mach-Zehnder interferometric system comprising:
a light source emitting source beam;
a first beam-splitter to split the beam from the light source to generate a reference path and a sample path;
a specimen;
a means to direct the sample path light to the specimen;
a second beam-splitter to combine the light backscattered from the specimen and the reference path light to generate an interference light beam;
the interference light beam is passed through a grating light valve;
a detector coupled to the grating light valve for detecting the interference light beam;
the reference arm light further being reflected by a reference minor;
a third beam splitter arranged to intersect the sample arm light;
the sample path light further passing through the third beam-splitter to direct the light to the specimen;
the light backscattered from the specimen returning to the third beam splitter;
the reflected light in the reference arm returning to the second beam splitter;
the backscattered sample arm light is re-reflected through the third beam splitter to the second beam splitter; and
the re-reflected backscattered sample arm light is interfered with the reference arm light.

2. The interferometric system of claim 1, wherein the specimen is at least one of a scattering medium or a biological specimen.
